(19) United States
(12) Patent Application Publication
(10) Pub. No.: US 2007/0140930 A1
(43) Pub. Date: Jun. 21, 2007

(54) GATE-BIASED ENHANCEMENT OF CATALYST PERFORMANCE

(76) Inventors: James Novak, Austin, TX (US); Zvi Yaniv, Austin, TX (US); Richard Lee Fink, Austin, TX (US); Igor Pavlovsky, Austin, TX (US)

Correspondence Address: FISH & RICHARDSON P.C., P.O BOX 1022, Minneapolis, MN, 55440-1022, US

(21) Appl. No.: 11/558,365

(22) Filed: Nov. 9, 2006

Related U.S. Application Data
(60) Provisional application No. 60/735,604, filed on Nov. 10, 2005.

(51) Int. Cl. B01J 19/08

(52) U.S. Cl. 422/186; 422/211

(57) ABSTRACT

The effectiveness of a catalyst is enhanced by using an applied voltage to raise the Fermi-level energy thus populating the conduction band and possibly the reaction band.

This application claims priority to U.S. Provisional Application Ser. No. 60/735,604.

### TECHNICAL FIELD

This invention relates to generation and enhancement of a catalytic effect through a gated voltage bias.

### BACKGROUND INFORMATION

A catalyst is a substance that increases the rate of a reaction or reduces the activation energy of the reaction and can be recovered chemically unchanged at the end of the reaction. A catalyst provides an alternate mechanism that is faster or lower energy than the mechanism in the absence of the catalyst. Although the catalyst participates in the mechanism, it is not consumed during the chemical reaction. Many catalytic effects in order to work necessitate a surface energy that basically will raise the energy of electrons in the catalytic layer in order for the catalytic effect to take place. For example, metal oxide sensors that use a catalytic effect (e.g., a tin oxide CO (carbon monoxide) sensor) need to be heated to over 300° C. in order for the catalytic effect to take place, oxidize CO to CO₂, and CO gas to be sensed. Another example is TiO₂ (titanium oxide) that needs to be irradiated with UV (ultraviolet) light in order for a catalytic effect to take place.

The catalytic process generally follows a standard path. In either a liquid or gas phase, a process or source molecule lands on the catalyst, then a reaction takes place that activates the molecule. The activated species react with other molecules or the catalyst and then moves away from the catalyst. If the catalyst is consumed in the initial reaction, it can be refreshed from other molecules in the ambient through follow-on reactions, thus bringing the catalyst to its initial state.

There are many factors that affect the rate of reaction. Initial reactions may require an activation energy that can be delivered by heating the catalyst and reactant molecules to high temperatures or by exposing it to light or other electromagnetic energy. Thus, the effectiveness of a catalyst has been shown in the prior art to increase with the addition of heat (changing the temperature) and/or the addition of light energy (photo-excitation of the catalyst or reactants at the catalyst surface). A problem with heating and UV radiation is that they complicate the overall system, possibly even causing the system to be unusable or lower the efficiency of the system.

### DETAILED DESCRIPTION OF DRAWINGS

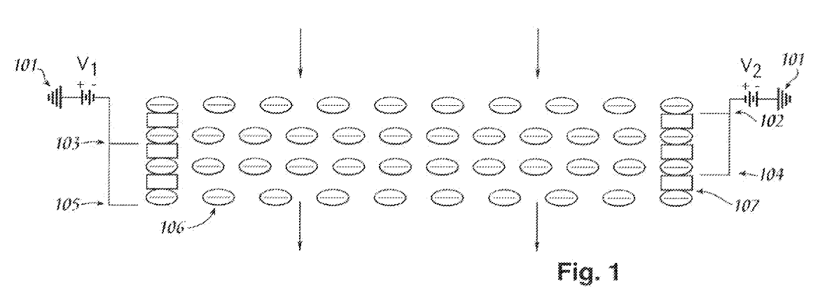

FIG. 1 illustrates an embodiment of the present invention;

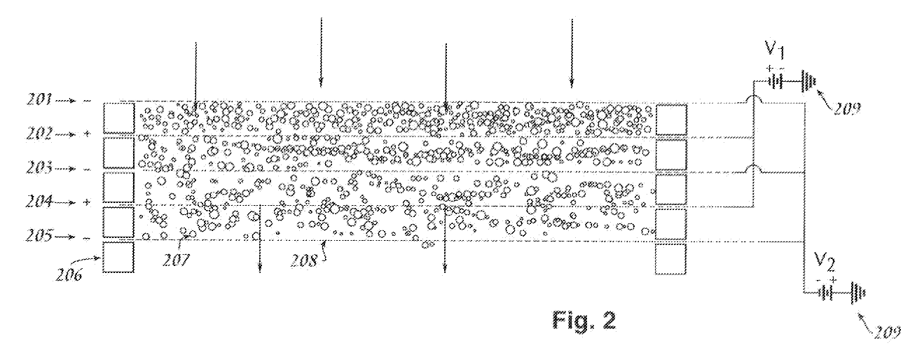

FIG. 2 illustrates an embodiment of the present invention;

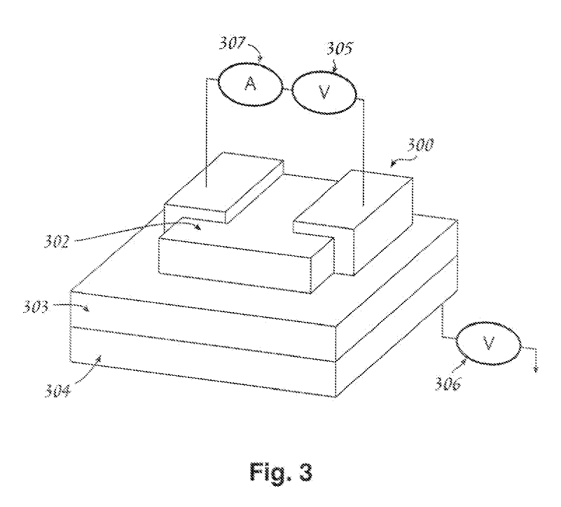

FIG. 3 illustrates an embodiment of the present invention;

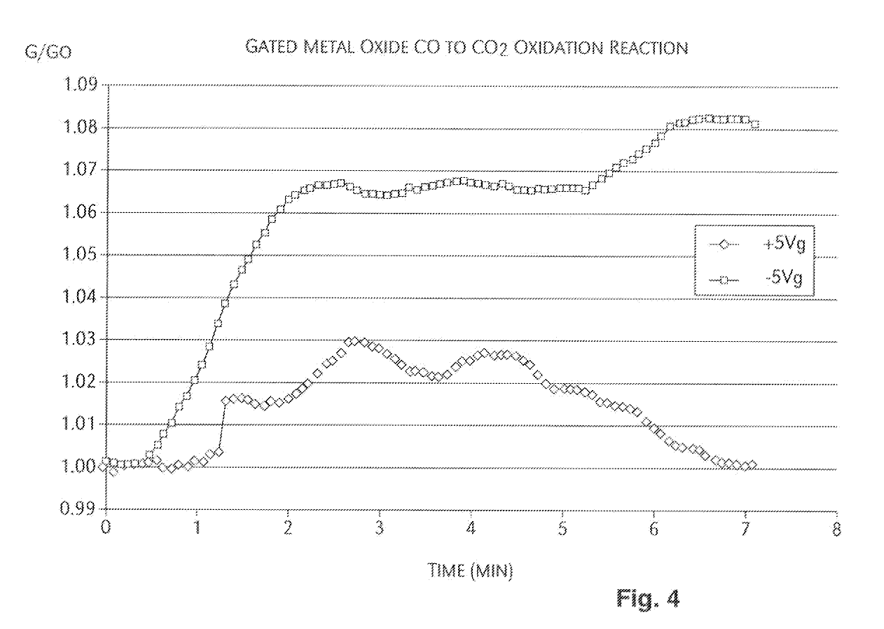

FIG. 4 illustrates measurement of a change in conductivity upon the oxidation of CO to CO₂ to two different gate-biased values;

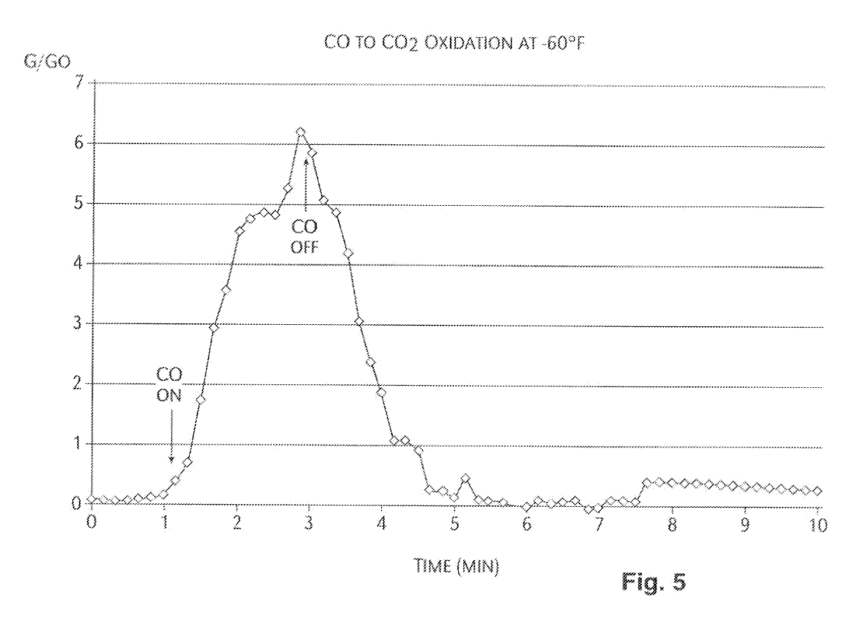

FIG. 5 illustrates a graph of a measurement of a change in conductivity upon the oxidation of CO to CO₂ with −10 volts on the gate electrode at −60° F.;

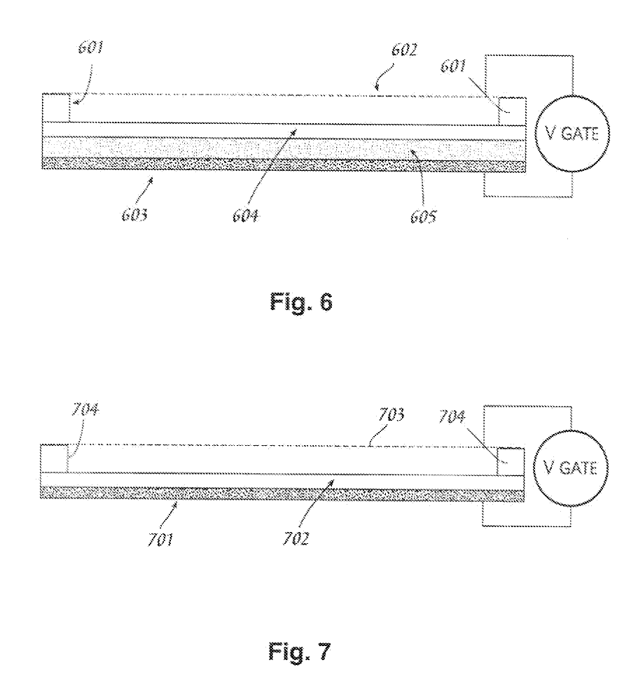

FIGS. 6-7 illustrate alternative embodiments of the present invention; and

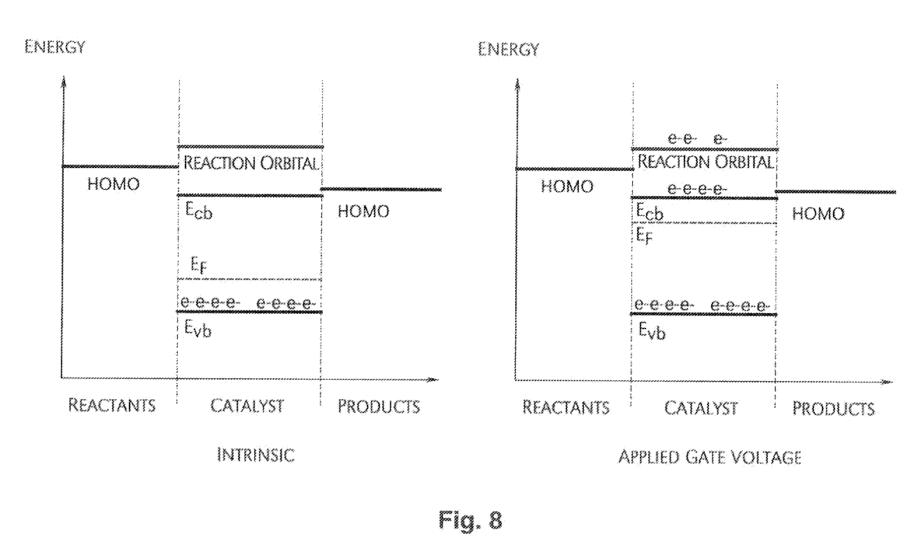

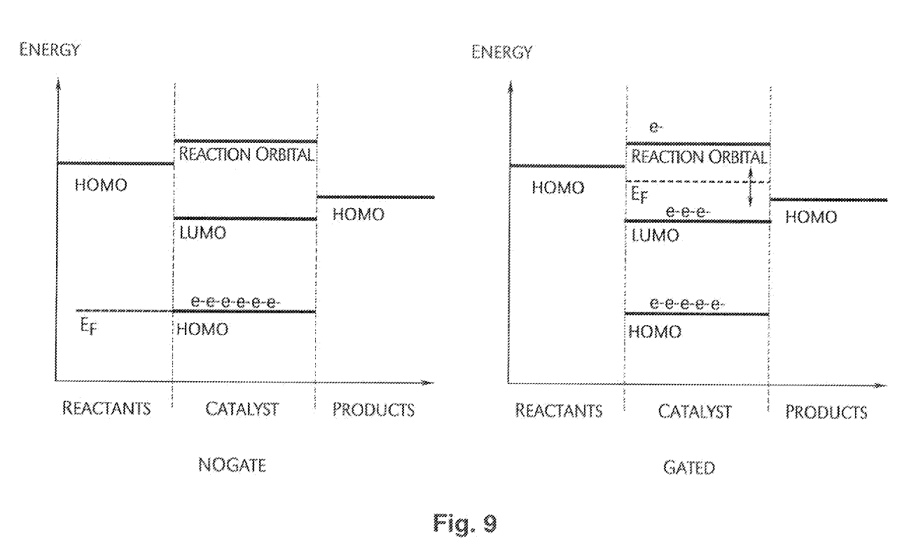

FIGS. 8-9 illustrate changes in Fermi levels.

### DETAILED DESCRIPTION

Embodiments of the present invention use a source of energy that is created by a voltage gated bias to a catalytic layer Due to the fact that heating or UV irradiation or other types of external energy sources complicate the system and sometimes even make the applications unusable, using a solid gated bias simplifies catalytic applications, and also reduces costs and miniaturizes the system.

Referring to FIG. 3, in the case of a CO sensor 300, instead of heating, a gated bias of 6 volts may be used to facilitate a catalytic reaction, resulting in sensing of CO gas. The sensor sits on top of a Si back gate 304 insulated from shorts via a 250 nm thick film of thermally grown silicon oxide 303. A molybdenum thin film 302 is deposited using electron beam evaporation onto the pre-patterned substrate. The pattern may be formed using standard photolithography techniques such as deposition and lift-off. This metal film is then converted to molybdenum oxide and is the active area of the sensor. Conductive electrical contact pads 301 are then deposited using photolithography and lift-off, and may be titanium. Typically, these pads are referred to as source and drain in a standard transistor configuration. The voltage 305 across the pads 301 in V_{Drain}, while the voltage on the back gate electrode 304 is V_{Gate}.

The conductivity of the sensor 300 is monitored during exposure to the gas by monitoring the current between the source and drain electrodes (301) using a current meter (307). In this embodiment, the gas is carbon monoxide (CO). At the surface of the sensor, the CO gas is catalytically converted to CO₂ by oxidation reaction in the presence of air or oxygen. This oxidation reaction provides an extra electron in the metal oxide film 302 that is detected as a change in conductivity, and thus a change in the current measured by the current meter (307) when the applied voltage (305) is held constant. This change in conductivity, and thus sensor response, is dependent on the voltage 306 applied to the gate. The output of the catalyst is the CO₂ gas that is generated by the catalytic reaction. This reaction is monitored by the change in conductivity across the catalytic film 302 as a result of the donated electron per CO molecule that is converted to CO₂. From one point of view, the sensor is measuring the presence of CO, but from another point of view, it is measuring the performance of the catalyst in the presence of CO. Thus, the sensor, in effect, is measuring the effectiveness of the molybdenum oxide catalyst 302. The reaction takes place even if the change in conductivity of the catalyst film is not measured.

The performance of sensor 300 is shown in FIG. 4. A negative gate voltage creates a more sensitive sensor. This graph shows the response of the sensor 300 to carbon monoxide at two gate voltages of −5 V and +5 V. On exposure to CO, the sensor 300 shows a larger increase in conductivity occurs when the gate voltage is at −5V, resulting in an increase in conductance as plotted in FIG. 4. The sensor 300 does not show any significant change in conductivity when the gate bias is +5 V. This defines a non-heated sensor that responds at room temperature at a negative gate voltage. The negative gate bias is acting in the same manner as raising the temperature. The negative gate bias is changing the Fermi-level of the sensor 300 allowing a facile catalytic oxidation of CO.

The response of the sensor 300 to CO at −60° F. is shown in FIG. 5. Achieved is a sensor response at a low temperature previously not obtained in metal oxide gas sensors. The non-heated, gated sensor 300 responds to CO even at this cold temperature. This is one more example of how a gate bias can eliminate the thermal requirements of a catalytic system. In addition, observed is an increase in the magnitude of the sensor response at lower temperatures compared with higher temperatures (for example, 150° F.). This may be due to the increased binding lifetime of CO on the surface of the sensor 300 when this sensor is at lower temperatures. The longer the analyte lifetime on the surface, the better chance that CO will be oxidized and the sensor 300 will show a sensor response. The increase in response may be due to more molecules completing their oxidation to CO₂ at this lower temperature, i.e., the sensor 300 is more efficient. This same process will correlate with other catalytic materials providing an increase in efficiency even when not heated.

Some of this increased efficiency may be tied to thermal transport and reaction energy levels. Hot surfaces (for heated catalysts) can provide diffusion input due to temperature differentials within a given system. A reactant will start to heat up as it diffuses toward the heated surface. As this reactant absorbs energy in the form of heat, it has a greater probability of diffusing away without having reacted. A non-heated, gated catalyst surface does not create these diffusion conditions, increasing the likelihood of the reaction taking place.

It is well known that catalysts are used to reduce the energy level (or energy barrier) for a reactant to become a product. This energy barrier is usually overcome by application of heat that creates a new population of electrons in an energy level within a materials band structure. This newly popullated energy level is where the catalytic reaction takes place. The temperature-based distribution of electrons follows Fermi-Dirac Statistics. The Fermi-Dirac distribution function describes the probability that an available energy state (E) will be occupied by an electron at a given temperature T. The distribution function is:
f(E)=1/(1+e^{(E-Ef)k(b)*T})
where k(b) is Boltzmann's constant and Ef is the Fermi-level energy. For any semi-conducting material Ef describes the probability of an electron to occupy its lowest energy band, the highest occupied molecular orbital (HOMO) or the next higher energy band, the lowest unoccupied molecular orbital (LUMO). Two scenarios of energy levels are considered for the catalyst embodiments of this patent. The first scenario is shown in FIG. 8. For many semi-conducting materials, the difference in energy between the LUMO and HOMO is on the order of 2-3 electron volts. This large energy difference is called a band gap. The HOMO and LUMO will now commonly be renamed the valence band and conduction band. Consider a band or orbital where a reaction takes place at some reaction energy level higher than the conduction band. At an intrinsic setting where no gate voltage is applied, there are always electrons present in the valence band. However, there is not enough energy available for an electron to be present in the reaction orbital. When the Fermi-level energy is raised, the population of electrons in the conduction band increases. Depending on the amount of energy required to get to the reaction band, there may be electrons present there as well. Temperature and light can raise the intrinsic populations of electrons in the valence and conduction band by exceeding the band gap. This would be the case for a heated semiconducting catalyst. When a gate bias is applied, the Fermi-level energy is raised thus populating the conduction band and possibly the reaction band activating the catalyst. This describes the electronic application of a catalyst through an applied gate bias. From the Fermi-distribution function described above, the occupation of an energy state can be manipulated with temperature, the Boltzmann's distribution or Fermi-level energy, and presumably with combinations thereof.

In another scenario, the catalyst has a smaller difference in energy between the HOMO and LUMO but the catalytic reaction may take place in a different molecular that is, for example, a higher energy than the LUMO. This is shown in FIG. 9. In order to populate this energy level for a reaction to take place there must be an input of energy to shift the Fermi-distribution of electrons. The energy input may be light, heat (temperature) or a gate bias to raise the Fermi-level energy. Combinations of these three may also be used. For example, a lower temperature may be obtained by the simultaneous application of a gate bias.

The scope of this disclosure is not limited to the observed phenomena of this sensor An applied field or gate bias on a catalyst surface may increase the effectiveness of the catalyst surface or film. This may arise as a result of the applied bias shifting the energy levels of the catalyst and making open states (unoccupied states) available to the reactant molecule that are not available without the applied bias.

There are many industrial manufacturing processes that also depend on semiconducting catalysts.

1. A SOHIO (Standard Oil of Ohio) process involving oxidation/ammoxidation of propylene to make acrolein and acrylonitrile. One of the catalyst used in this case is bismuth molybdenum oxides, although multi-component catalysts (including Bi, Mo, Fe, Ce, etc.) are also used. Typically, this catalyst is heated to 300° C.-400° C.

2. Supported molybdenum oxide (MoO₃/Al₂O₃) catalyst was studied for the oxidative dehydrogenation of ethane. The demand for olefins remains a challenge for the refining and petrochemical industry. The classical commercial processes applied for the production of olefins are energy-intensive; more economic sources are sought. (See “an operando Raman study of structure and reactivity of alumina-supported molybdenum oxide catalysts for the oxidative dehydrogenation of ethane,” A. Christodoulakis, E. Heracleous, A. A. Lemonidou, and S. Boghosian J. Catal. 2006, Vol. 242, pp 16-25.)

3. Tin oxide (SnO₂) is used as an oxidation catalyst for carbon monoxide (CO). (See “The surface and materials science of tin oxide,” M. Batzill and U. Diebold Progress in Surface Science 2005 Vol. 79, pp. 47-154.) SnO₂ is also used in many heated metal oxide sensors.

4. Vanadium oxide (V₂O₃) with various loadings of titanium oxide (TiO₂) is used for selective oxidation of methanol to formaldehyde (See “In situ IR, Raman, and U-Vis DRS spectroscopy of supported vanadium oxide catalysts during methanol oxidation.” L. J. Burcham, G. Deo, X. Gao, and I. E. Wachs Top. Catal. 2000 11/12, 85) and selective reduction (See “Reactivity of V₂O₅ Catalysts for the Selective Catalytic Reduction of NO by NH₃: Influence of Vandadia loading, H₂O and SO₂,” M. D. Amiridis, E. E. Wachs, G. Deo, J.-M. Jehng, and D. S. Kim J. Catal. 1996 Vol. 161, p. 247) of NOₓ by NH₃.

5. Zinc oxide (ZnO₂) is used for the production of H₂ via steam reformation of ethanol (See “Current Status of Hydrogen Production Techniques by Steam Reforming of Ethanol: A Review,” A. Haryanto, S. Fernando, N. Murali, and S. Adhikari Energy & Fuels 2005 19, 2098)

These processes may take place at lower temperature and be more efficient or the production of the reactant product (e.g., acrolein and acrylonitrile in example 1 above) may be more complete if the catalyst was biased with a gate voltage or if an electric field was applied to the catalytic film.

There are also some catalytic reactions processes where the catalyst material creates different products when not heated. In this example, a normal catalyst produces a mixture of enantiomers of a chiral molecule. The heat of reaction for the catalyst's activation provides enough energy to overcome the formation of both enantiomers of the chiral product. The application of a gate bias may reduce the temperature enough so that only one of the two chiral products is produced. The reduction or elimination of heat and addition of a gate bias to the catalyst may also direct the reaction intermediates that take place and thus products from a directed chemical mechanism. In other words, it may be used to steer the reaction in one direction or another. This may be useful in the creation of bio-molecules or natural products synthesis.

Thus, there are other configurations that may allow a gate bias or electric field to be applied to a semiconducting or wide band gap catalytic film. The polarization of the applied gate bias may also be important; for the example of the CO sensor 300 of FIG. 3, a negative bias on the gate electrode was used. Other systems may respond to a positive bias, depending on whether the semiconductor catalyst was n-type or p-type.

FIG. 6 shows another configuration of applying an electrical bias or electrical field to a catalyst. In FIG. 6, the catalyst layer 604 is deposited on top of a insulating layer 605. A conducting electrode 603 called gate electrode is on the opposite side of the insulating layer 605. Suspended above the catalyst film is another gate electrode 602. This gate electrode 602is supported by gate spacer posts 601 that are also insulating. A gate bias is applied between the suspended gate electrode 602 and the bottom gate electrode 603. The direction of the V_{gate} bias is determined on a case-by-case basis by the material of the catalyst and the reaction that is promoted by the catalyst. In operation, this assembly is exposed to gas or fluid and a reaction takes place to form product chemicals. The catalyst promotes this reaction. The presence of a proper bias to the gate electrodes enhances the performance of the catalyst, resulting in reduction of heat or other energy applied to the catalyst (not shown in FIG. 6), thus resulting in a more efficient process, or increasing the yield of the reaction by creating more product material.

FIG. 7 is another embodiment of a biased catalyst and is similar to FIG. 6. In FIG. 7, there is no insulating layer and the catalyst layer 702 is deposited directly on top of the bottom gate electrode 701. The gate electrode 703 may be a conducting film on a supporting substrate (not shown) or it may be a free-standing conducting sheet, such as metal foil. A suspended gate electrode 703 is placed above the catalytic surface, supported by gate spacers 704. A gate bias V_{gate} is placed between the bottom electrode 701 and suspended electrode 703. The direction of the V_{gate} bias is determined on a case-by-case basis by the material of the catalyst and the reaction that is promoted by the catalyst In operation, this assembly is exposed to gas or fluid and a reaction takes place to form product chemicals. The catalyst promotes this reaction. The presence of a proper bias to the gate electrodes enhances the performance of the catalyst, resulting in reduction of heat or other energy applied to the catalyst (not shown in FIG. 7), thus resulting in a more efficient process, or increasing the yield of the reaction by creating more product material.

These configurations may be used in a gas phase system or in a liquid phase system, as long as a bias is able to be maintained between the various electrode surfaces.

Thus, the effectiveness of a catalyst has been shown in prior art to increase with addition of heat (changing the temperature) and/or the addition of light energy (photo-excitation of the catalyst or reactants at the catalyst surface). A catalyst material may also demonstrate increased effectiveness (higher catalytic response and greater product yield) by adding a gate bias or electric field to the catalyst.

Referring to FIG. 2, there is illustrated another embodiment of the present invention. Each layer of mesh 201-205 is alternately biased positive and negative or positive and ground (V₂ is zero) or negative and ground 209 (if V₁ is zero). V₁ and V₂ may be the same value or different values. V₁ and V₂ are connected directly to alternating layers of conducting mesh 201-205. In one embodiment, these values are constant (DC), but in principle they may also be varying with time or may be controlled with a feedback loop from a reaction monitoring signal in order to throttle the reaction or to modify the product reactants as reaction parameters change, such as changing input chemical concentrations. Examples of a reaction monitoring signal are signals from sensors that measure temperature or concentrations of one or more chemicals in the process flow, either upstream or downstream of the catalyst or even changes in the properties of the catalyst itself such as the change in conductivity seen in the CO sensor described in FIG. 3 and shown in FIG. 4 and FIG. 5.

Particle catalyst 207 is a bed of particles between layers of conducting mesh 208 divided by insulating spacers 206. Particles 207 may be vanadium oxide, tin oxide or other semiconducting or wide band gap material. Particle sizes may range from 10 microns to 1 nm (nanometer). The mesh 201-205 is constructed to contain the catalyst particles 207. The catalyst particles 207 may be mixtures of different materials (e.g., tin oxide particles mixed with vanadium oxide). The catalyst particles 207 may be one material coated with another material (e.g., Al₂O₃ coated with vanadium oxide). The configuration can be heated or cooled to further control reaction processes. In operation, this assembly is exposed to gas or fluid flow and a reaction takes place to form product chemicals. The catalyst particles 207 promote this reaction. The presence of the proper bias to the mesh electrodes 201-205 enhances the performance of the catalyst, resulting in reduction of heat or other energy applied to the catalyst (not shown in FIG. 2), thus resulting in a more efficient process, or increasing the yield of the reaction by creating more product material.

FIG. 1 illustrates another alternative embodiment. Layers of metal or conducting mesh 102-105 are coated with a catalyst film 106. The layers 102-105 are electrically biased opposite to each other V₁ and V₂ may be the same value or different values. V₁ and V₂ are connected directly to alternating layers of conducting mesh 102-105. Similar to FIG. 2, V₁ and V₂ are held constant, but in principle they may also be varying with time or could be controlled with a feedback loop from a reaction monitoring signal in order to throttle the reaction or to modify the product reactants as reaction parameters change. A semiconducting or wide band gap catalyst material (e.g. tin oxide, vanadium oxide, etc.) is coating 106 part or all of the conducting mesh 102-105. The layers 102-105 may have the same coating or they may have alternative coatings. There may be as many different coating materials as there are layers. The coating for each layer may consist of multiple materials and one coating may be on top of another coating. The coating may be rough or smooth. There are multiple ways of coating the mesh. This embodiment is not dependent on the means of coating the conducting mesh. The assembly may be temperature controlled by heating or cooling the gas or fluid flow or by heating or cooling the mesh assembly. In operation, this assembly is exposed to gas or fluid flow and a reaction takes place to form product chemicals. The catalyst coating 106 will promote this reaction. The presence of the proper bias to the mesh electrodes 102-105 enhances the performance of the catalyst, resulting in reduction of heat or other energy applied to the catalyst (not shown in FIG. 1), thus resulting in a more efficient process, or increasing the yield of the reaction by creating more product material.

For any of the embodiments described in FIGS. 1, 2, 3, 6 and 7, the catalyst may be titanium dioxide (titania). Titania is a photocatalyst. A photocatalyst is a catalytic material that is activated by illuminating it with light. The effectiveness of Titania photocatalyst may be increased with an application of bias potential. The photocatalytic material consists of support coated with a conductive metallic layer. Subsequently titania is placed onto the conductive layer and covered with a conducting mesh transparent to light and placed a distance above the titania layer using spacers. The material is shown in FIG. 7 but other configurations shown in this application may also be applied.

Titania is a wide-band-gap semiconductor with the energy gap of 3.03 eV or 3.18 eV for rutile and anatase phases, respectively. One of the factors dictating the electron distribution between the conductive and valence bands is dictated by Fermi-Dirac statistics. The electron distribution may be affected by shifting the Fermi energy level. The closer the Fermi energy level is to a particular energy band (e.g., conductive band), the more electrons will occupy this band. If there are more electrons in the conduction band, then there are more electrons available to perform chemical reactions. One way to adjust the Fermi energy level is to apply the bias potential as described herein. As stated before, this may also affect the direction of a reaction towards one product or another.

Another way to affect the Fermi energy level and thus further increase the effectiveness of the titania photocatalyst, is to dope the titania with n-type material fabricating for example titania-doped stabilized tetragonal zirconia (TiO_{[2]}—ZrO_{[2]}—Y₂O_{[3]}) material which is a n-type semiconductor. This method may be combined with the application of the bias potential to achieve a synergistic effect.

Typically, UV light is required to achieve the activation of the titania photocatalyst. Decreasing the activation energy requirements to allow use of visible light commonly available in sunlight, one would need to substantially decrease a band-gap of titania. This may be achieved by doping titania with nitrogen as widely discussed in literature. Therefore, to utilize all of the above enhancements one would synthesize nitrogen-doped (n-type) titania material and subject it to the bias potential.

What is claimed is:

1. A catalytic device to perform a chemical reaction where there is a conductive gate biased with a voltage, a gate insulator and a catalytic material placed on top of the gate insulator.

2. The catalytic device as recited in claim 1 wherein the catalytic material is a metal oxide.

3. The catalytic device as recited in claim 1 wherein the catalytic material is semiconducting.

4. The catalytic device as recited in claim 1 wherein the voltage changes an energy level distribution of the catalytic material.

5. The catalytic device as recited in claim 1 wherein the voltage bias changes the Fermi-level energy of the catalytic material.

6. The catalytic device as recited in claim 1 wherein the voltage bias changes a distribution of electrons within energy levels of the catalytic material.

7. The catalytic device as recited in claim 1 wherein the catalytic material has occupied and unoccupied molecular orbitals.

8. The catalytic device as recited in claim 7 wherein the voltage bias changes a number of electrons within the molecular orbitals.

9. A catalyst material that changes its energy level by application of a gate bias voltage.
